(19) United States
(12) Patent Application Publication
(10) Pub. No.: US 2021/0390881 A1
(43) Pub. Date: Dec. 16, 2021

(54) ASSISTIVE COMMUNICATION DEVICE, METHOD, AND APPARATUS

(71) Applicant: 2542202 ONTARIO INC., East York (CA)

(72) Inventors: Ling LY TAN, East York (CA); Mark TUCCI, Keswick (CA)

(21) Appl. No.: 17/287,270

(22) PCT Filed: Oct. 21, 2019
(86) PCT No.: PCT/IB2019/058934

§ 371 Date: Apr. 21, 2021

Related U.S. Application Data
(60) Provisional application No. 62/748,605, filed on Oct. 22, 2018.

(51) Int. Cl. G09B 21/00; G09B 5/06; G06F 3/0482

(52) U.S. Cl. CPC G09B 21/00; G06F 3/0482; G09B 5/06

(57) ABSTRACT

Communication devices, apparatuses, and methods to assist an individual to develop communicative ability are disclosed. A communication device includes a communication module to generate a user interface to display word tiles for selection, compile a sentence upon selection of word tiles, and output the sentence. A first word tile is associated with a word and at least two stimuli of the word, the at least two stimuli including at least two of a text transcription of the word, a visual depiction of the word, and a vocal expression of the word. The communication device includes a training module to collect interaction data, the interaction data including indications of interactions of a user account with the communication module over a plurality of trials, and to progressively diminish at least one of the at least two stimuli of the word of the first word tile based on the interaction data.

### FIELD

The present disclosure relates generally to assistive communication tools and methods of use thereof.

### BACKGROUND

Some individuals diagnosed with autism, global developmental delays (GDD), acquired brain injury (ABI) or progressive neurological diseases may suffer from a reduced ability to use vocal speech to communicate with others. Such individuals may use assistive communication tools, known as Augmentative and Alternative Communication (AAC) tools, to communicate. An AAC may encompass a variety of methods used to communicate, such as gestures, sign language and picture symbols. An example of an AAC tool is a communication board in which the individual selects or points toward a picture on the communication board to convey a message to another person.

Some individuals may become accustomed to communicating through picture symbols at the expense of developing of written communication skills and learned relations between pictures, written text and the auditory forms of words. For example, an individual may be capable of communicating to another person that they are thirsty by pointing to a picture of water on a communication board, but the individual may be incapable of speaking or writing the word “water”.

### SUMMARY

According to an aspect of the specification, a communication device is provided which may be used to improve communicative ability of an individual. The communication device includes a communication module to generate a user interface, the user interface to display word tiles for selection, compile a sentence upon selection of word tiles, and output the sentence. A word tile is associated with a word and at least two stimuli of the word, the at least two stimuli including at least two of: a text transcription of the word, a visual depiction of the word, and a vocal expression of the word. The communication device further includes a training module to collect interaction data, the interaction data including indications of interactions of a user account with the communication module over a plurality of trials, and to progressively diminish at least one of the at least two stimuli of the word of the first word tile based on the interaction data.

According to another aspect of the specification, a method for assisting an individual to develop communicative ability is provided. The method includes providing a communication interface to the individual, the communication interface displaying word tiles for selection by the individual to form a sentence, wherein a first word tile is associated with a word and at least two stimuli of the word, the at least two stimuli including at least two of: a text transcription of the word, a visual depiction of the word, and a vocal expression of the word. The method further involves facilitating interaction of the individual with the communication interface to build a plurality of sentences. The method further involves progressively diminishing at least one of the at least two stimuli of the word based on the individual's interaction with the communication interface.

According to yet another aspect of the specification, a communication apparatus is provided. The communication apparatus includes a communication display surface displaying word tiles, wherein a first word tile is associated with a word and displays a text transcription of the word and a visual depiction of the word, and an implement manipulable to diminish visibility of the visual depiction of the word.

### BRIEF DESCRIPTION OF THE DRAWINGS

FIG. 1 is a schematic diagram showing an example process by which an individual may develop stimulus relations.

FIG. 2 is a schematic diagram of an example system for assisting an individual to develop communicative ability. The system includes a communication device.

FIG. 3A is a schematic diagram showing an example user interface of a communication application executable by the communication device of FIG. 2. The user interface displays word tiles showing visual depictions of words and corresponding text transcriptions of the words.

FIG. 3B is a schematic diagram showing the example user interface of FIG. 3A with an example menu for a caregiver to provide input.

FIG. 3C is a schematic diagram showing the example user interface of FIG. 3A with an example word insertion element.

FIG. 3D is a schematic diagram showing the example user interface of FIG. 3A with an example sentence extender element.

FIG. 4A shows an example sequence of the progressive diminishment of the visual depictions of words of certain word tiles of the user interface of FIG. 3A.

FIG. 4B shows an example sequence of the progressive diminishment of the visual depictions of words of certain word tiles of the user interface of FIG. 3A and the corresponding progressive emphasis of the text transcriptions of the words.

FIG. 5 is a schematic diagram showing another example user interface of the communication application of FIG. 2. The user interface displays word tiles showing visual depictions of words and corresponding text transcriptions of the words, the visual depictions of the words of certain word tiles having been diminished.

FIG. 6A is a schematic diagram showing example user interface menus for configuring the communication application of FIG. 2.

FIG. 6B depicts an example progress chart to display a user's progress using a communication application to construct sentences.

FIG. 6C depicts an example session history log to display a history of a user's interaction with a communication application to construct sentences.

FIG. 7 is a schematic diagram showing an example communication apparatus.

### DETAILED DESCRIPTION

According to relational frame theory, an individual may develop stimulus relations as the individual engages in communication in which a caregiver interacts with the individual using a variety of stimuli and reinforces successful stimuli associations. For example, a caregiver may show a physical object to an individual and reinforce the individual speaking the name of the object. With further teaching to develop relations, a caregiver may gesture toward the object, and ask “what is it?” and reinforce the individual selecting the written word of the object from a communication board. With relational frame theory, additional relations may emerge, such as when the caregiver says the word of the object, and the individual selects the written word of the object. As such, stimulus relations between auditory, visual, and textual stimuli may be developed.

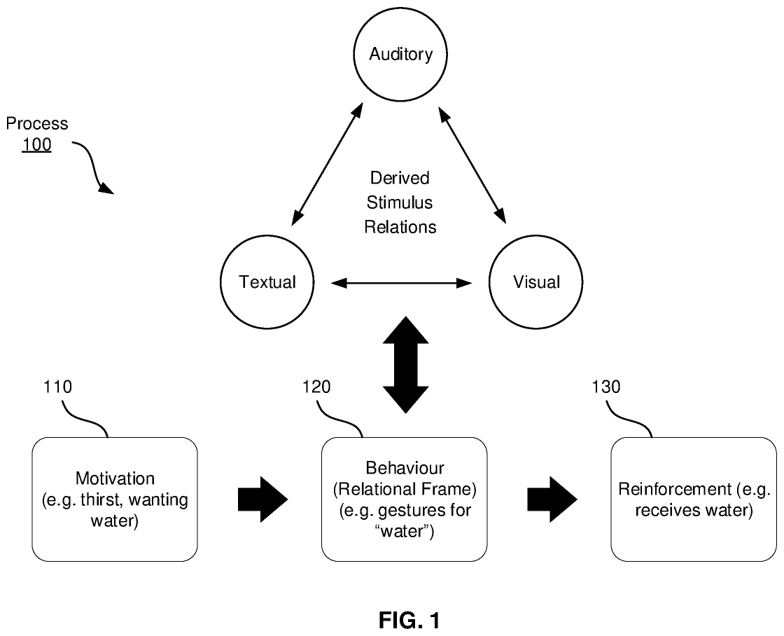

An example process 100 for the development of such stimulus relations is depicted in FIG. 1. At block 110, an individual has a motivation, such as a thirst and/or a desire for water. At block 120, the individual exhibits a behaviour to communicate the motivation. The behaviour may involve the individual drawing on any of the developed stimulus relations, such as, for example, pointing toward a picture of water in a picture communicator. In such an example, the individual is using a visual stimulus (e.g., selecting the picture of water). The individual may have developed stimulus relations which may allow the user to use an additional stimulus, such as an auditory or textual stimulus, i.e., to speak or write the word. However, these stimulus relations may be undeveloped. Through successive communication trials and reinforcement, these stimulus relations may emerge and/or strengthen. At block 130, if the behaviour successfully communicates the motivation, the behaviour is reinforced.

Stimulus relationships may be developed through stimulus equivalence or mutual entailment of stimuli by the individual engaging with multiple stimuli during the course of communication. An individual may thereby develop equivalencies or mutual entailments between several different stimuli with respect to a particular concept.

According to the methods described herein, the individual may be progressively weaned off of reliance on one or more of the stimuli, such as the visual stimuli, to strengthen the individual's reliance on other stimuli (e.g., written stimuli). For example, where an individual has developed a strong reliance on visual stimuli to communicate, the individual may be encouraged to rely more heavily on textual or auditory stimuli, i.e., by engaging in written or oral communication. The individual may thereby strengthen their communicative ability.

Thus, a communication device, method, and communication apparatus are provided to assist an individual to develop communicative ability. Use of the communication device, method, and communication apparatus involve progressively diminishing certain stimuli to reduce the individual's reliance on the diminished stimuli and to reinforce the individual's reliance on other stimuli.

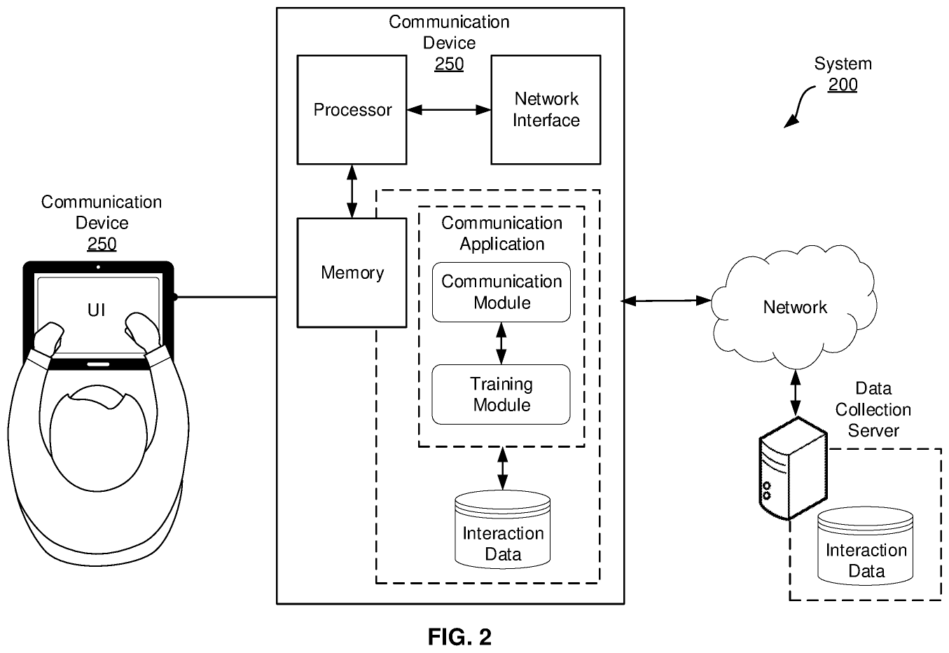

FIG. 2 is a schematic diagram of such an example system 200 for assisting an individual to develop linguistic capabilities. The system 200 includes a communication device 250. The communication device 250 includes a processor, network interface, and memory.

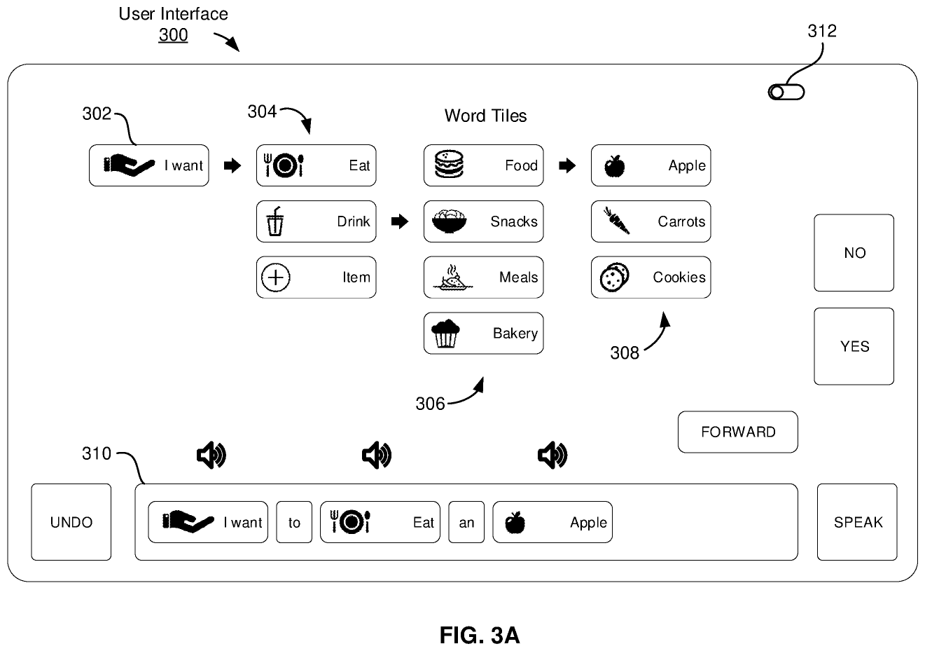

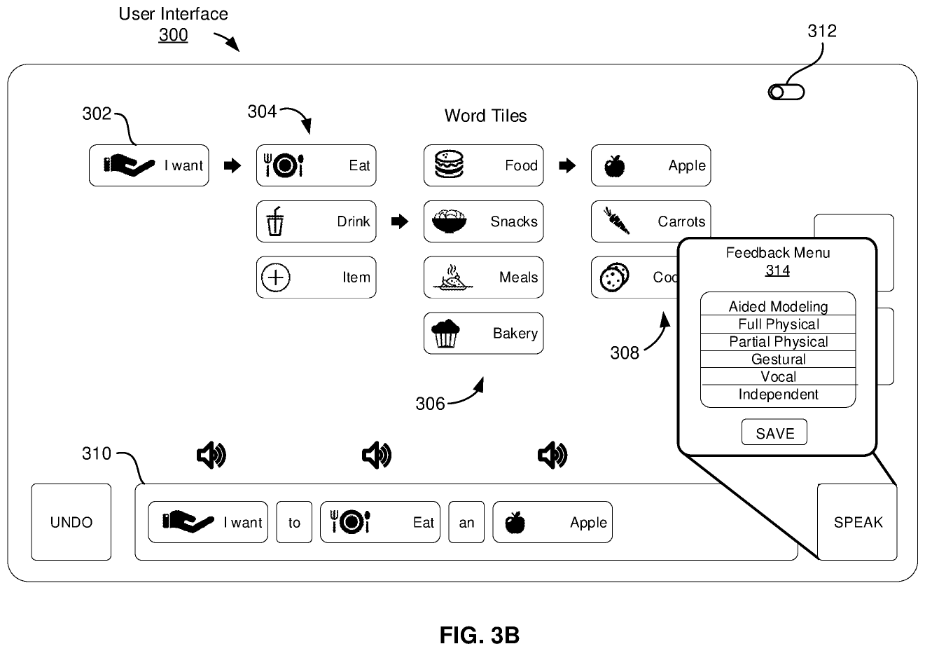

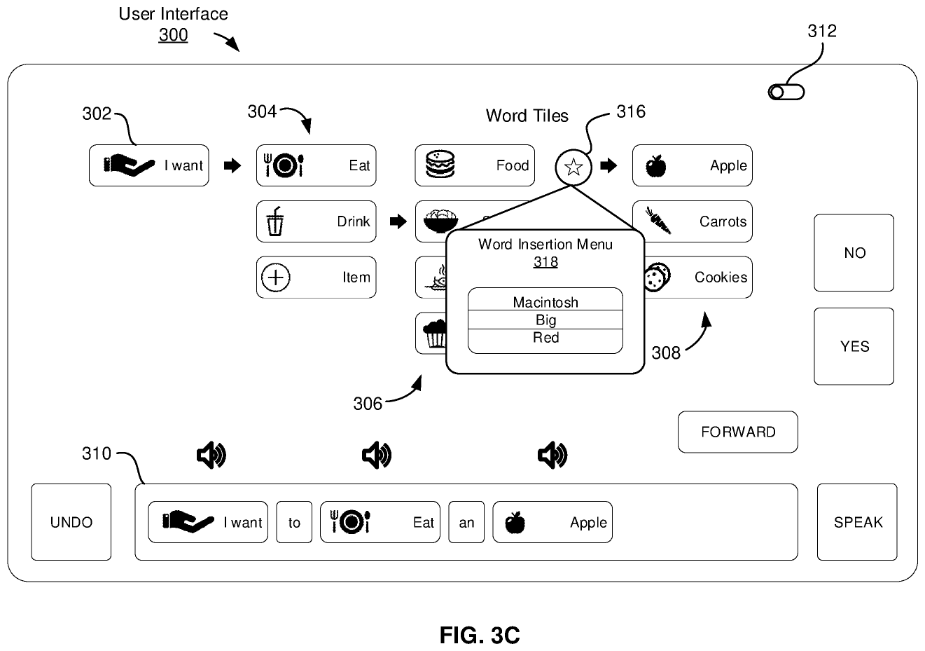

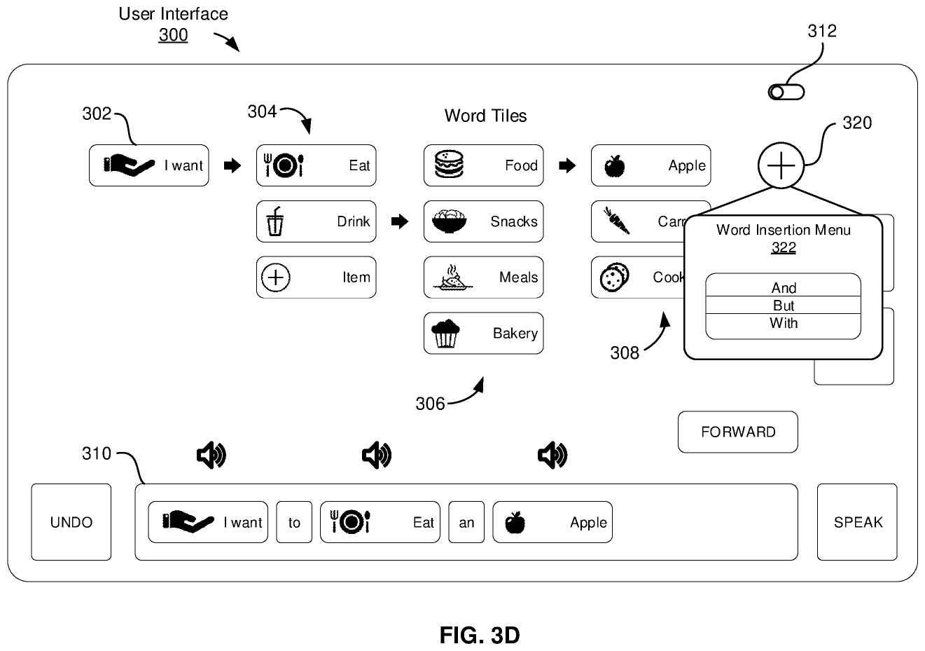

The memory stores a communication application (e.g., a software application) to assist an individual with communication and to assist the individual to develop communication capabilities. The communication application includes a communication module to generate a user interface. The user interface displays word tiles for selection by an individual, compiles a sentence upon the individual's selection of word tiles, and outputs the sentence to communicate with another person. An example of such a user interface displaying word tiles is provided in FIG. 3A, below. As will be seen in FIG. 3A, each word tile is associated with a word (word(s), phrase(s), etc.), and is associated with at least two stimuli of the word. The stimuli include may include a text transcription of the word, a visual depiction of the word, and a vocal expression of the word.

With continued reference to FIG. 2, the communication application includes a training module to collect interaction data. The interaction data includes indications of interactions of a user account with the communication module over a plurality of trials, which may indicate that the individual is becoming progressively more proficient at using the communication device 250 to communicate. Based on the interaction data, the training module causes the communication module to progressively diminish at least one of the at least two stimuli of a word tile. Thus, as an individual becomes more proficient with communicating using the communication device 250, certain stimuli associated with the word tiles of the user interface may be diminished, thereby weaning the individual off of the diminished stimuli, and reinforcing the individual's ability to communicate using the other stimuli associated with the word tile.

The processor may include any quantity and combination of a processor, a central processing unit (CPU), a microprocessor, a microcontroller, a field-programmable gate array (FPGA), and similar. The network interface may include programming logic enabling the communication device 250 to communicate over one or more computing networks, is configured for bidirectional data communications through any network used, and accordingly can include a network adaptor and driver suitable for the type of network used. The memory includes a non-transitory computer-readable medium for storing programming instructions executable by the processor. The memory may include volatile storage and non-volatile storage. Volatile storage may include random-access memory (RAM) or similar. Non-volatile storage may include a hard drive, flash memory, and similar.

The communication device 250 may communicate over one or more computing networks with a data collection server. The data collection server may store interaction data from a plurality of communication devices 250. The interaction data stored on the data collection server may be accessed as a cloud computing service to allow an individual to share their data across multiple communication devices 250. The interaction data may further be used to gain insights into the progress of the individual, or a plurality of individuals, using the communication devices 250. Analysis of the interaction data may be incorporated into aspects of the communication module or the training module. For example, training schedules may be informed by analysis of the interaction data.

FIG. 3A is a schematic diagram showing an example user interface 300 of the communication application executable by the communication device 250. The user interface 300 displays word tiles showing visual depictions of words and corresponding text transcriptions of the words. For example, the word tile for “want” includes the text transcription “I want” and a visual depiction of the word “want”.

A word tile may also be associated with a vocal expression of the word. For example, selection of a word tile may cause the communication device 250 to produce an audible sound of the vocalization of the word, either upon selection of the word tile or upon output of a sentence constructed using the user interface 300.

Thus, word tiles are associated with words, and are associated with at least two stimuli of the word, wherein the stimuli may be a text transcription of the word, a visual depiction of the word, or a vocal expression of the word.

Selection of a word tile may provide for the selection of additional selection of word tiles so that the user may select several words to be compiled into a sentence for output. For example, selection of a first word tile 302 may generate a group 304 of additional word tiles, and selection of a word tile from the group 304 may generate an additional group 306 of still additional word tiles, the selection of which may generate an additional group 308 of still additional word tiles, and so on.

Word tiles may be organized into groups, categories, and/or hierarchies to provide for ease of selection. These groups, categories, and/or hierarchies may be connected in that the selection of one word tile may generate an additional group of word tiles for selection by the user. Thus, an individual may select word tiles by navigating through a mapping of connected word tiles. For example, the word tile “I want” may be connected to the word tiles for “Eat” and “Drink” and “Item” as these word tiles represent logical ideas that could follow “I want”. The word tiles may be stored in a word tile library stored in a database with the appropriate linkages.

The mapping of connected word tiles may be hard-coded by a user or may be generated dynamically. Thus, in some examples, the selection of a particular word tile may cause the communication module to pull a following additional group of word tiles from a word tile library and present the group of word tiles to the individual in a particular order according to pre-determined rules. These pre-determined rules may be configured to follow grammar rules. Further, these pre-determined rules may be programmed by a person, such as a caregiver of the individual, to develop a library of connected word tiles that would suit the needs of the individual in that commonly used word tiles are presented to the individual most conveniently. For example, a caregiver may develop a library of connected word tiles in which the word tile “I want” is connected to “to play”, and “to play” is connected to the individual's favourite activities, such as “baseball” or “cards”.

In other examples, the selection of a particular word tile may cause the dynamic generation of a following group of word tiles, wherein the following group is generated according to a predictive algorithm. The predictive algorithm may involve presenting the individual with word tiles which have been most commonly selected by the individual in the past, which may change over time. As another example, word tiles may be presented to the individual based on commonly selected word tiles according to interaction data stored on the data collection server. A predictive algorithm may include a machine learning algorithm.

As word tiles are selected, the selected word tiles may be stored in a sentence container 310. As word tiles are included in the sentence container 310, additional sentence structure elements, such as articles, prepositions, or other words and/or punctuation, may be generated and inserted as appropriate into the sentence container 310. The communication module may include a natural language processor and/or generator to generate such additional sentence structure elements.

Once a sentence is formed, the individual may press a button (e.g. “speak”) to output the sentence and empty the sentence container 310 for another sentence to be compiled. Outputting the sentence may involve playing an audio transcription of the compiled sentence for a caregiver to hear. The user interface 300 may also include a button to undo an action such as an addition of a word tile to the sentence container 310 (e.g. an “undo” button).

The user interface 300 may also include buttons to output simple responses, such as “yes” and “no” for ease of communication. The user interface 300 may also include buttons to navigate larger menus of word tiles (e.g. a “forward” button to flip to another page of word tiles).

The user interface 300 may also provide a mechanism for a caregiver to provide input to the communication application regarding the performance of the individual. For example, as shown in FIG. 3B, upon outputting a sentence, the user interface 300 may generate a feedback menu 314 for the caregiver to interact with to provide a response related to the user's performance. Using the feedback menu 314, the caregiver may indicate whether the individual manually selected any of the word tiles, whether the caregiver assisted the individual, and if assistance was provided, the type of assistance provided, such as whether the caregiver provided aided modeling assistance, full physical assistance, partial physical assistance, gestural physical assistance, vocal assistance, or whether the user performed independently with no assistance. Such information may be incorporated into the interaction data to as an indication of the progress of the individual. For example, an individual who tends to construct sentences independently may be considered to be more developed than an individual who tends to construct sentences with assistance. The user interface 300 may include a toggle button 312 to enable and disable the collection of interaction data by a user's use of the interface 300. The toggle button 312 may further enable the feedback menu 314 to appear when the collection of interaction data is enabled, and disable the feedback menu 314 from appearing when the collection of interaction data is disabled.

The user interface 300 may include additional user interface elements to assist a user to construct a sentence. As shown in FIG. 3C, the user interface 300 includes a word insertion element 316 operable to insert a word in front of a word that was previously selected in a fully or partially constructed sentence. For example, when the word-insertion element 316 is selected, a word insertion menu 318 may appear which provides options for words for a user to insert before a particular word. The word insertion element 316 may be located proximate to the word tile associated with the particular word, as shown, to indicate that operation of the word tile 316 is to modify the particular word. The inserted word may include an adjective, preposition, or any other word that may grammatically precede the particular word. In the example shown, the user has selected the words “I want”, “eat”, “snacks”, and “apple”, to generate the sentence “I want to eat an apple” as shown in the sentence container 310, and the word insertion element 316 is operable to insert any of the words “Macintosh”, “big”, or “red” before the word “apple” from the word insertion menu 318 before the word “apple” to modify the word “apple”. The word insertion menu 318 may also provide an element for choosing a category of words for selection. As discussed herein, the words made available by the word insertion menu 318 may be selected from the library of word tiles.

As another example, as shown in FIG. 3D, the user interface 300 includes a sentence extender element 320 operable to insert a word at the end of a fully or partially constructed sentence. For example, when the sentence extender element 320 is selected, a word insertion menu 322 may appear which provides options for words for a user to insert at the end of the sentence. For example, the sentence extender element 320 is operable to insert any of the words “and”, “but”, and “with” from the word insertion menu 322 at the end of the sentence. The word insertion menu 322 may also provide an element for choosing a category of words for selection. As discussed herein, the words made available by the word insertion menu 322 may be selected from the library of word tiles.

As an individual practices communication with the user interface 300, the individual may become more proficient with the use of some of certain word tiles. Early in the training process, the individual may be relying on one of the stimuli associated with the word tiles more than other stimuli. For example, the individual may be relying on the visual depiction of the word shown on a particular word tile to conclude that that word tile is the word tile they wish to select. As the individual becomes more proficient with the use of certain word tiles, the training module of the communication application may note this development in the interaction data. For example, an individual requiring less prompting (guidance) to select a word tile from a menu of word tiles may indicate that the individual is more proficient at selecting that word tile. This may further indicate that the individual has improved at building an association between the stimuli associated with the word tile and is ready to be weaned off of reliance on the visual stimuli. As an individual becomes more proficient at selecting a particular word tile, the training module may cause the communication module to generate that word tile with one of the stimuli diminished in other trials using the communication device 250, thereby reducing the individual's reliance on that diminished stimuli, and encouraging the individual to rely on the other stimuli. For example, the communication module may diminish the visibility of the visual depiction of the word on a given word tile. Thus, as the individual continues to practice with the user interface 300, the individual is progressively weaned off of reliance on the visual depiction of words, and encouraged to draw on associations with text transcriptions of words to communicate. In other examples, the textual stimuli may be diminished. In still other examples, the auditory stimuli may be diminished. Thus, an individual can thereby be assisted to develop communicative ability.

Thus, in use, a method for as assisting an individual to develop communicative ability is provided. The method involves providing a communication interface (such as, for example, user interface 300) to the individual. The communication interface displays word tiles for selection by the individual to form a sentence, wherein word tiles are associated with a word and at least two stimuli of the word. The stimuli may include a text transcription of the word, a visual depiction of the word, and a vocal expression of the word.

The method further involves facilitating interaction of the individual with the communication interface to build a plurality of sentences. Thus, a caregiver may interact with the individual to induce the individual to communicate using the communication interface.

The method further involves progressively diminishing at least one of the at least two stimuli of the word based on the individual's interaction with the communication interface. Thus, as the individual continued to use the communication interface, the individual may progressively develop communicative ability language and communication skills.

In some examples, it is contemplated that any of the three stimuli associated with word tiles, visual, textual, or auditory, may be progressively diminished in this manner. For example, the auditory and/or visual stimuli may be progressively diminished in favour of the text stimuli. The mode of progressively or systematically diminishing stimuli may be selected to suit the needs of any given individual.

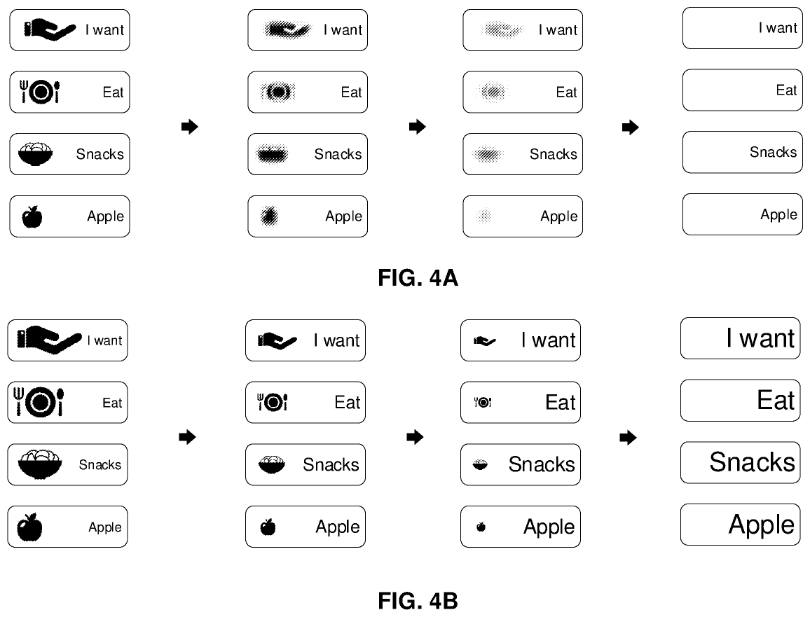

Further, the progression of the diminishment of stimuli may follow any pre-determined training schedule to suit the needs of any given individual. For example, some stimuli may be diminished linearly, according to a schedule of thresholds, or any other algorithm. Moreover, different modes for diminishing stimuli are also contemplated. FIGS. 4A and 4B provide examples.

FIG. 4A shows an example sequence of the progressive diminishment of the visual depictions of words of certain word tiles of the user interface 300. In this example, the visibility of the visual depiction of each word tile is diminished by being faded out from visibility.

FIG. 4B shows another example sequence of the progressive diminishment of the visual depictions of words of certain word tiles of the user interface 300. In this example, the visibility of the visual depiction of each word tile is diminished by reducing the size of the visual depiction. Further, the text transcription of each word tile is correspondingly increased in size to emphasize the textual stimuli.

In examples in which the auditory stimuli is to be diminished, the audibility of the vocalization of the word may be decreased by, for example, lowering the volume of the output sound, or by delaying output of the sound to provide the user with an opportunity to vocalize the sound themselves. Such diminishment, including the degree by which audibility is decreased, and the duration of delay of the sound, may be configured by a caregiver through a user interface. Further, such diminishment may be updated as the user progresses as discussed herein.

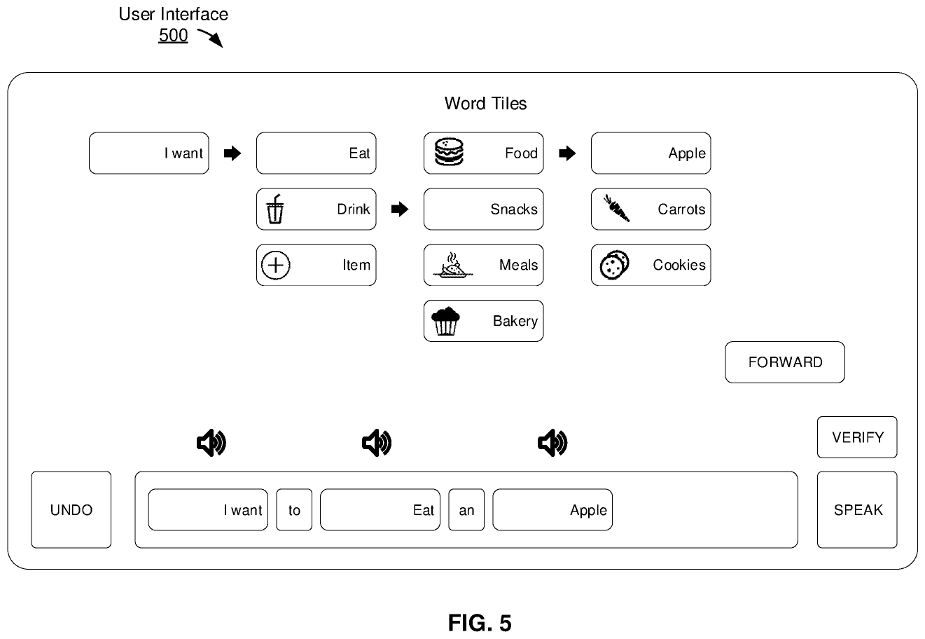

FIG. 5 is a schematic diagram showing another example user interface of the communication application. The user interface 500 is similar to the user interface 300, except that the user interface 500 includes certain word tiles having diminished stimuli. The user interface 500 provides an example of how such a user interface may look after the individual has developed sufficient proficiency with certain word tiles. Thus, as shown, the word tiles for “I want”, “eat”, “snacks”, and “apple” have had the visual depiction of the respective words completely diminished.

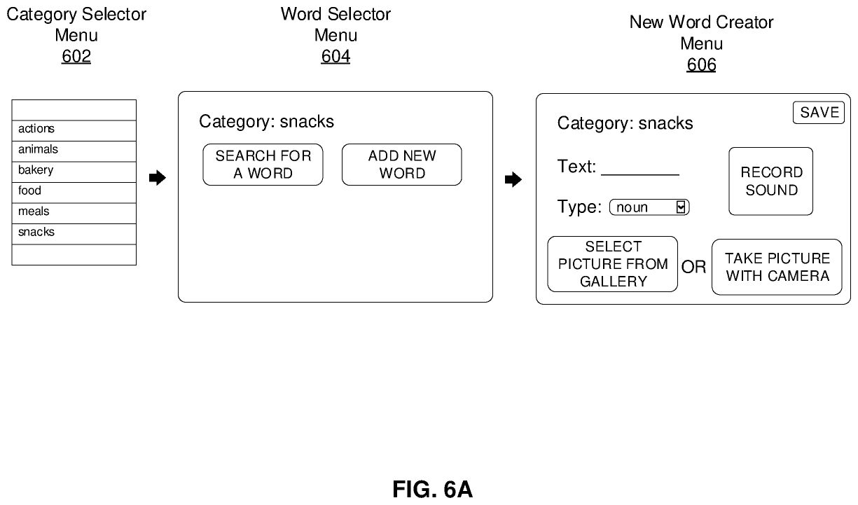

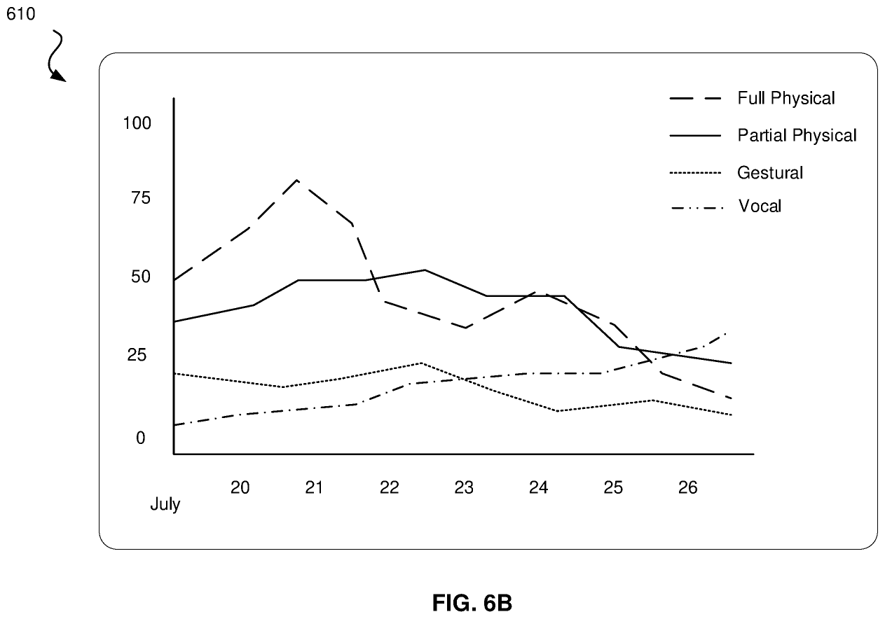

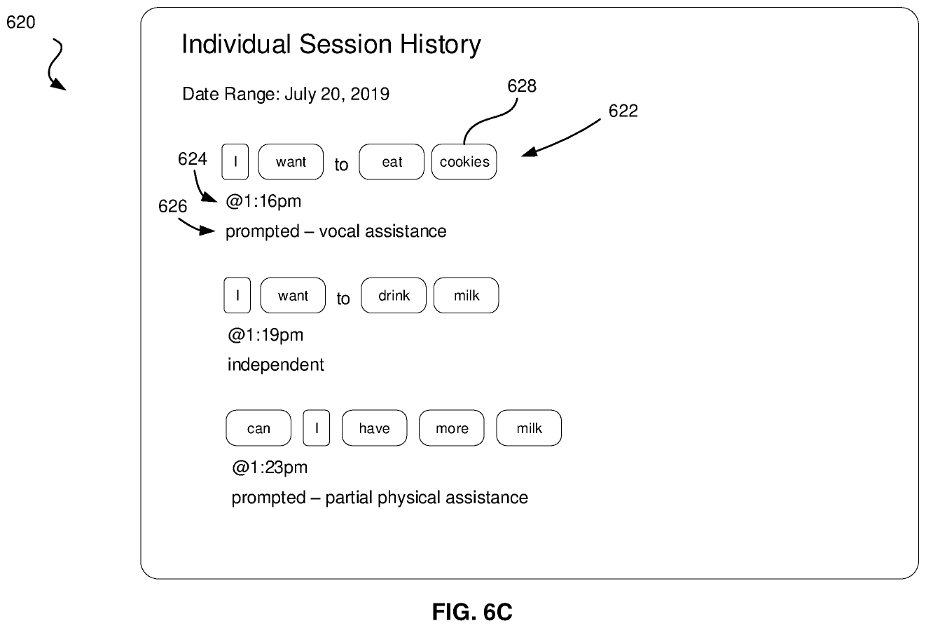

FIG. 6A is a schematic diagram showing example user interface menus for configuring the communication application. These interface menus may be used (typically by the caregiver of the individual) to add word tiles to a library of word tiles. The menus include a category selector menu 602, a word selector menu 604, and a new word creator menu 606.

The category selector menu 602 may be used to select a category for a new word tile. The word selector menu 604 may be used to search for a word in a database of pre-configured word tiles to be added to the individual's pool of word tiles, or to add a new word to the database. The new word creator menu 606 may be used to input the text transcription of a word, provide grammatical information relating to the word (such as whether the word is a noun, verb, adjective, is plural, etc.), to add a visual depiction of the word (e.g. by taking a picture using the communication device 250 or by selecting an image from a gallery), and to add a vocal expression of the word (e.g. by recording the spoken word). A user, such as a caregiver on an individual, may thereby add word tiles to a library of word tiles to be used by the communication application. In other examples, vocal expressions of words may be associated with computer-generated vocalizations of the words.

FIG. 6B depicts an example progress chart 610 to display a user's progress using a communication application to construct sentences. The progress chart 610 indicates the number instances in which different forms of assistance were provided by a caregiver throughout a period of time. The progress chart 610 may be generated by interaction data collected as discussed herein, and may be consulted to review the progress of the individual. As shown, the dashed line represents the number of instances in which the user was provided with full physical assistance, the solid line represents the number of instances in which the user was provided with partial physical assistance, the dotted line represents the number of instances in which the user was provided with gestural assistance, and the dash-dotted line represents the number of instances in which the user was provided with vocal assistance. As can be seen, the frequency that the user received full physical assistance, partial physical assistance, and gestural assistance, has fallen over time, while the frequency that the user received vocal assistance as increased slightly. Such information may inform a caregiver of the user's progress and allow the caregiver to adapt his or her care strategy accordingly.

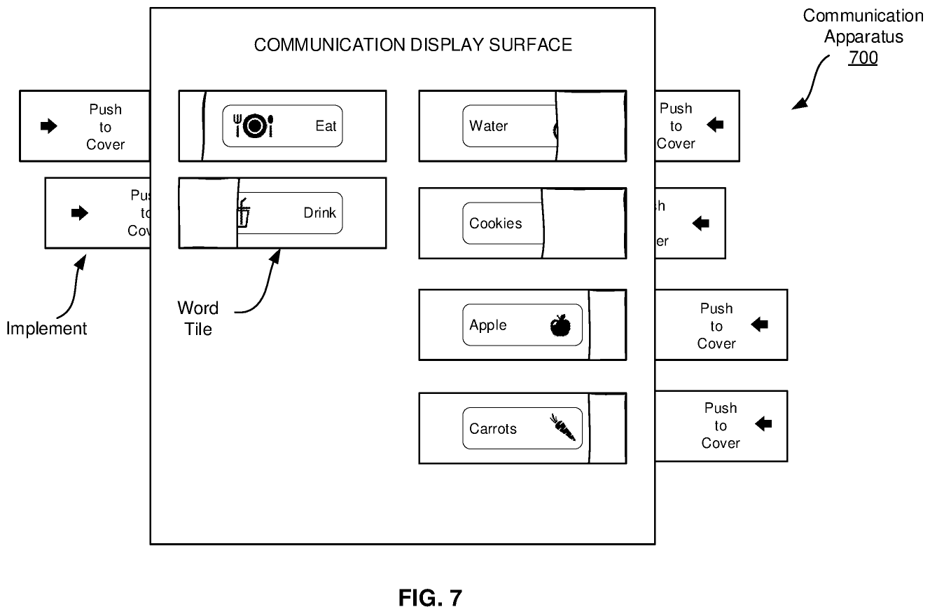

FIG. 6C depicts an example session history log 620 to display a history of a user's interaction with a communication application to construct sentences. The session history log 620 provides a list of sentences 622 constructed by the user, an indication 624 of a time at which the sentences 622 were constructed, and an indication 626 of what kind of assistance the user received, if any. Thus, a caregiver may review a user's progress with the communication application to consider whether the user is increasing or reducing reliance on any form of assistance. Such information may inform a caregiver of the user's progress and allow the caregiver to adapt his or her care strategy accordingly. In some examples, the sentences 622 may be displayed using the word tiles 628 selected by the user. In some examples, the word tiles 628 may be provided with visual depictions of the words, which may be diminished according to the amount of diminution at the time the sentence was constructed. Thus, the caregiver may further review a user's progress with reference to whether the user received assistance and whether the user was aided by visual depictions of the words. FIG. 7 is a schematic diagram showing an example communication apparatus 700. The communication apparatus 700 includes a communication display surface for displaying word tiles. A word tile on the communication display surface is associated with a word, and displays a text transcription of the word and a visual depiction of the word. For example, the communication display surface includes a word tile for “eat” including a visual depiction related to eating, a word tile for “drink” including a visual depiction related to drinking, and so on.

The communication apparatus 700 further includes, an implement which is manipulable to diminish visibility of the visual depiction of the word of a word tile. For example, the implement may include a slider which is configured to slide into a slot on the communication display surface to cover the visual depiction of a word of a word tile.

In use, a method for as assisting an individual to develop linguistic capabilities is provided. The method includes providing a communication interface (such as, for example, the communication apparatus 700) to the individual. The communication interface displaying word tiles for selection by the individual to form a sentence. A word tile is associated with a word and displays a text transcription of the word and a visual depiction of the word.

The method further involves facilitating interaction of the individual with the communication interface to build a plurality of sentences. Thus, a caregiver may interact with the individual to induce the individual to communicate using the communication interface.

The method further involves progressively diminishing visibility of the visual depiction of a word of a word tile word based on the individual's interaction with the communication interface. Thus, as the individual continued to use the communication interface, the caregiver may note the individual's progress with developing proficiency selecting word tiles, and progressively cover the visual depictions of words accordingly. The individual may thereby progressively develop communicative ability.

In other examples, the visual depiction of the word may be diminished by the caregiver cutting away portions of the visual depiction of the word, drawing over the visual depiction of the word, or otherwise obscuring view of the visual depiction of the word.

In still other examples, the communication device 250 or the communication apparatus 700 may be used to develop communicative ability for people suffering from dementia. Auditory voices may interfere with the communicative ability of some individuals suffering from dementia. Thus, in such examples, where an auditory stimulus is included, the auditory stimuli may be progressively diminished throughout trials to reduce interference caused by auditory stimuli.

Thus, an individual may be assisted to develop communicative ability using the communication device, communication apparatus, and/or methods described herein. The individual may be assisted on an ongoing basis or over a predetermined number of teaching trials. By encouraging an individual to rely on different stimuli, the individual may become more proficient at communicating in different modes. For example, by encouraging the individual to rely on text to communicate, the individual may be assisted in the development of the proficiency of using other devices such as computers. As another example, by encouraging the individual to rely on auditory prompts or stimuli to communicate, the individual may be assisted in the development of proficiency in oral communication.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A communication device comprising:
a communication module to generate a user interface, the user interface to:
display word tiles for selection;
compile a sentence upon selection of word tiles; and
output the sentence;
wherein a first word the is associated with a word and at least two stimuli of the word, the at least two stimuli including at least two of: a text transcription of the word, a visual depiction of the word, and a vocal expression of the word; and
a training module to collect interaction data, the interaction data including indications of interactions of a user account with the communication module over a plurality of trials, and to progressively diminish at least one of the at least two stimuli of the word of the first word the based on the interaction data.

2. The communication device of claim 1, wherein the at least two stimuli of the word comprise the text transcription of the word and the visual depiction of the word, and wherein the training module is to progressively diminish visibility of the visual depiction of the word.

3. The communication device of claim 2, wherein the training module is further to progressively emphasize visibility of the text transcription of the word.

4. The communication device of claim 1, wherein the at least two stimuli of the word comprises the vocal expression of the word, and wherein the training module is to progressively diminish audibility of the vocal expression of the word.

5. The communication device of claim 1, wherein the at least two stimuli of the word comprises the vocal expression of the word, and wherein the training module is to delay output of the vocal expression of the word.

6. The communication device of claim 1, wherein the training module is to progressively diminish the at least one of the at least two stimuli of the word according to a pre-determined training schedule.

7. The communication device of claim 1, wherein the training module is to progressively diminish the at least one of the at least two stimuli of the word when the interaction data indicates that a user of the user account has improved at building an association between the at least two stimuli of the word.

8. The communication device of claim 1, wherein the communication device comprises a processor and a memory, the memory to store programming instructions executable by the processor to execute the communication module and the training module.

9. A method for assisting an individual to develop communicative ability, the method comprising:
providing a communication interface to the individual, the communication interface displaying word tiles for selection by the individual to form a sentence, wherein a first word tile is associated with a word and at least two stimuli of the word, the at least two stimuli including at least two of: a text transcription of the word, a visual depiction of the word, and a vocal expression of the word;
facilitating an interaction of the individual with the communication interface to build a plurality of sentences; and
progressively diminishing at least one of the at least two stimuli of the word based on the interaction of the individual with the communication interface.

10. The method of claim 9, wherein the at least two stimuli of the word comprise the text transcription of the word and the visual depiction of the word, and wherein the method comprises progressively diminishing visibility of the visual depiction of the word.

11. The method of claim 10, wherein the method comprises progressively emphasize visibility of the text transcription of the word.

12. The method of claim 9, wherein the at least two stimuli of the word comprises the vocal expression of the word, and wherein the method comprises progressively diminishing audibility of the vocal expression of the word.

13. The method of claim 9, wherein the at least two stimuli of the word comprises the vocal expression of the word, and wherein the method comprises delaying output of the vocal expression of the word.

14. The method of claim 9, wherein the method comprises progressively diminish the at least one of the at least two stimuli of the word according to a pre-determined training schedule.

15. The method of claim 9, wherein the method comprises:
collecting interaction data, the interaction data including indications of interactions of a user account with the communication module over a plurality of trials; and
progressively diminishing the at least one of the at least two stimuli of the word when the interaction data indicates that a user of the user account has improved at building an association between the at least two stimuli of the word.

16. A communication apparatus comprising:
a communication display surface displaying word tiles, wherein a first word the is associated with a word and displays a text transcription of the word and a visual depiction of the word; and
an implement manipulable to diminish visibility of the visual depiction of the word.
